(19) United States
(12) Patent Application Publication
(10) Pub. No.: US 2014/0349801 A1
(43) Pub. Date: Nov. 27, 2014

(54) Gearing Device With An Internally Toothed Internal Gear And Two Spur Gears Meshing Therewith

(71) Applicant: Klaus-Peter Brenner, Friedrichshafen (DE)

(72) Inventor: Klaus-Peter Brenner, Friedrichshafen (DE)

(21) Appl. No.: 14/364,903

(22) PCT Filed: Nov. 21, 2012
(86) PCT No.: PCT/EP2012/073212

§ 371 Date: Jun. 12, 2014

(30) Foreign Application Priority Data
Dec. 19, 2011 (DE) 10 2011 089 021.1

(51) Int. Cl. H02K 7/116; F16H 1/28

(52) U.S. Cl. CPC H02K 7/116; F16H 1/2863
USPC 475/149; 475/331

(57) ABSTRACT

The description relates to a gearbox arrangement (4) with an internally toothed ring gear (7) and two spur gears (5, 14) which mesh with the latter and which engage with a common intermediate gear (15), wherein at least one of the spur gears (5) is connected to a shaft (6) so as to be fixed with respect to rotation relative to it. According to the invention, the working pressure angle between the spur gears (5, 14) and the ring gear (7) is at least approximately, i.e. about identical in size.

### PRIORITY CLAIM

This is a U.S. national stage of application No. PCT/EP2012/073212, filed on Nov. 21, 2012. Priority is claimed on the following application: Country: Germany, Application No. 10 2011 089 021.1, Filed: Dec. 19, 2011, the content of which is incorporated herein by reference in its entirety.

### FIELD OF THE INVENTION

The invention is directed to a gearbox arrangement with an internally toothed ring gear and two spur gears meshing therewith and which engage with a common intermediate gear.

### BACKGROUND OF THE INVENTION

Serial hybrid drives in city busses are constructed inter alia with electro-portal axles with drive wheels in operative connection with electric machines via gearbox arrangements. The serial hybrid drives allow a particularly economical and environmentally sound operation under harsh inner-city conditions of use with many starting and braking processes.

The serial construction of a hybrid drive includes an internal combustion engine which is operated in conjunction with a generator as current generator. There is no direct mechanical connection between the internal combustion engine and the wheels. Via intermediate power electronics, the electric machines arranged in the area of the wheels are supplied with power by the generator and/or an electric energy accumulator for driving the wheels and/or the electric energy accumulator can be charged.

However, the flow of power can also be reversed in the serial hybrid drive so that the electric motors act as generators during a regenerative braking operation of a city bus and feed the supplied current back into the electric energy accumulator or batteries. Accordingly, the internal combustion engine or diesel engine is not the only energy source and can therefore be designed so as to be smaller with respect to its power capacity.

With appropriately designed electric drives arranged in the area of the wheels, it is also possible to provide full driving power when the internal combustion engine is turned off so that startup and shutdown at stops can be carried out with low emissions and reduced noise. Through optimal driveline management and downsizing, consumption values in the area of the internal combustion engine can be reduced by up to 30% depending on the case of application.

The serial principle also shows its flexibility in the design of the city bus. Since the drive energy is guided from the generator coupled with the internal combustion engine to the wheel-side electric drives via power cables, there are high degrees of freedom with respect to the arrangement of the drive components in a bus. In addition, it is also possible to make the passenger compartment larger compared to city busses of conventional construction because of the smaller dimensions of the internal combustion engine.

A gearbox arrangement which is constructed as a step-down transmission and which has an internally toothed ring gear and two spur gears meshing with the latter which engage with a common intermediate gear or with two common intermediate gears is known from EP 1 192 058 B1. The gearbox arrangement offers a simple possibility for constructing the electric drive of a city bus with lightweight electric machines in the area of, the drive wheels which only require a small installation space.

It is disadvantageous that a two-flank contact occurs in operation of the gearbox arrangement in the area of the teeth between the ring gear and spur gears which results in unwanted deformations in the area of the ring gear which is preferably thin-walled. These unwanted deformations in turn impair the life of the gearbox arrangement to an undesirable extent and cause operating noises which impair driving comfort.

Therefore, it is the object of the present invention to provide a gearbox arrangement with an internally toothed ring gear and two spur gears meshing with the latter which is characterized by long life and which can be operated with the least possible operating noise.

### SUMMARY OF THE INVENTION

In the gearbox arrangement according to the present invention with an internally toothed ring gear and two spur gears which mesh with the latter and which engage with a common intermediate gear, wherein at least one of the spur gears is connected to a shaft so as to be fixed with respect to rotation relative to it, service life is increased compared to solutions known from the prior art, and operating noises are reduced because the working pressure angle between the spur gears and the ring gear is at least approximately, i.e. about identical in size.

The present invention is based on the insight that a two-flank contact causing deformations in the area of the ring gear is prevented in a simple manner and the tooth forces in the meshing area between the spur gears and the ring gear are at least partially compensated when the working pressure angles in the area of the teeth between the spur gears and ring gear are at least approximately or about identical in size.

A long life and reduced operating noises are achieved in an advantageous further development of the gearbox arrangement according to the invention in that the working pressure angles between the toothed wheels and the intermediate gear correspond at least approximately or about to the working pressure angles between the spur gears and the ring gear in each instance.

When the two spur gears have different numbers of teeth, a total gear ratio of the gearbox arrangement can be predefined with a high degree of freedom.

When the sum of the backlash between a first spur gear and the ring gear and the sum of the backlashes between the first spur gear and the intermediate gear, between the intermediate gear and the second spur gear and between the second spur gear and the ring gear are at least approximately or about equal to zero, radial deflections of the first spur gear with respect to the ring gear in the event of a load change are minimal and loads in the area of the gearbox arrangement and operating noises can be reduced to a minimum in a simple manner with regard to construction.

In a further advantageous embodiment of the gearbox arrangement according to the invention, the ring gear is constructed with a number of teeth corresponding to an even natural number in order to achieve a phase synchronicity in the area of the gearbox arrangement that favorably affects the running behavior.

To operate the gearbox arrangement with high efficiency, a transverse contact ratio between the spur gears and the ring gear and between the spur gears and the intermediate gear is less than or equal to one in a further embodiment of the gearbox arrangement according to the invention.

In addition to an improvement in the load carrying capacity of the tooth base and flanks, a distinct improvement in the efficiency of the gearbox arrangement is also achieved when a normal pressure angle between the spur gears and the ring gear and between the spur gears and the intermediate gear is greater than or equal to 25 degrees in each instance.

In a further embodiment of the gearbox arrangement according to the invention which can likewise be operated at high efficiency, a roughness depth in the area of the teeth of the spur gears, of the ring gear and of the intermediate gear is less than or equal to 2 μm in each instance.

A further embodiment of the gearbox arrangement according to the invention which results in reduced noise during operation is formed with an overlap contact ratio of greater than two in the area between the spur gears and the ring gear and between the spur gears and the intermediate gear.

In further advantageous embodiments of the gearbox arrangement according to the invention, the spur gear can be coupled in the region of the shaft with an output shaft of an electric machine of an electro-portal axle of a vehicle, and/or the ring gear can be brought into an operative connection with a sun gear of a planetary gear arrangement of an electro-portal axle of a vehicle so that the vehicle having the gearbox arrangement, particularly a city bus, can be operated with high efficiency while reducing operating noises at the same time.

The features indicated in the patent claims as well as the features indicated in the following embodiment of the gearbox arrangement according to the invention are suitable by themselves or in any combination to further develop the subject matter of the invention. The respective combinations of features are not limiting as regards the further development of the subject matter of the invention but are merely essentially exemplary in character.

### BRIEF DESCRIPTION OF THE DRAWINGS

Further advantages and advantageous further developments of the invention follow from the patent claims and the embodiment described in principle with reference to the drawings in which:

FIG. 1 is a highly schematic view of a portion of an electro-portal axle of the gearbox arrangement according to the invention; and

FIG. 2 is a detailed side view of the gearbox arrangement according to FIG. 1.

### DETAILED DESCRIPTION OF THE PRESENTLY PREFERRED EMBODIMENTS

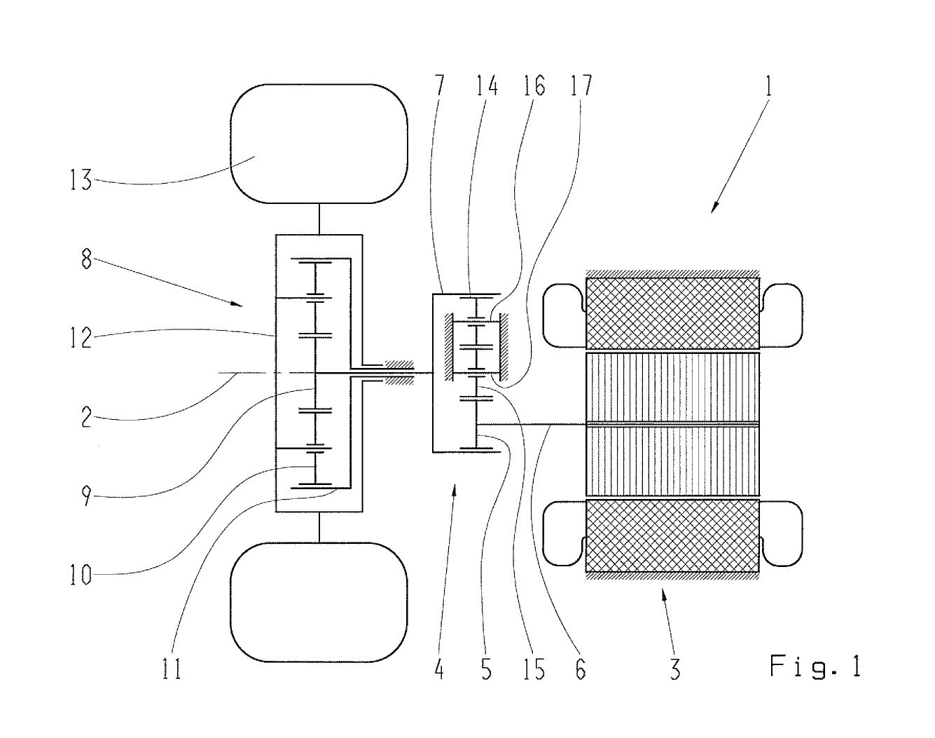

FIG. 1 shows a highly schematic view of a portion of an electro-portal axle 1 of a vehicle, constructed in the present case as a city bus, with an electric machine 3 constructed as an asynchronous motor which is constructed in a compact manner and which is arranged so as to be offset relative to the vehicle axle 2. The electro-portal axle 1 further comprises a gearbox arrangement 4 which is operatively connected in the area of a first spur gear 5 with the electric machine 3 via a shaft 6.

With regard to the electric machine 3, the gearbox arrangement 4 is coupled on the output side with a gear unit device 8 via a ring gear 7 meshing with the first spur gear 5. The ring gear 7 is connected to a sun gear 9 of the gear unit device 8 so as to be fixed with respect to rotation relative to it. The sun gear 9 meshes with planet gears 10 which engage in turn with a ring gear 11 of the gear unit device 8. In the area of a planet carrier 12, the gear unit device 8 is coupled with a drive wheel 13 so that the drive of the electric machine 3 is conveyed in direction of the drive wheel 13 via the gearbox arrangement 4 and the gear unit device 8.

In coast mode or during a braking operation of the vehicle constructed with the electro-portal axle 1, an overrun torque is guided from the drive wheel 13 via the gear unit device 8 and gearbox arrangement 4 in direction of the electric machine 3 which can then be operated as a generator. The electrical energy generated during generator operation in the area of the electric machine 3 can be recuperated, for example, in the area of an electric storage device of the vehicle.

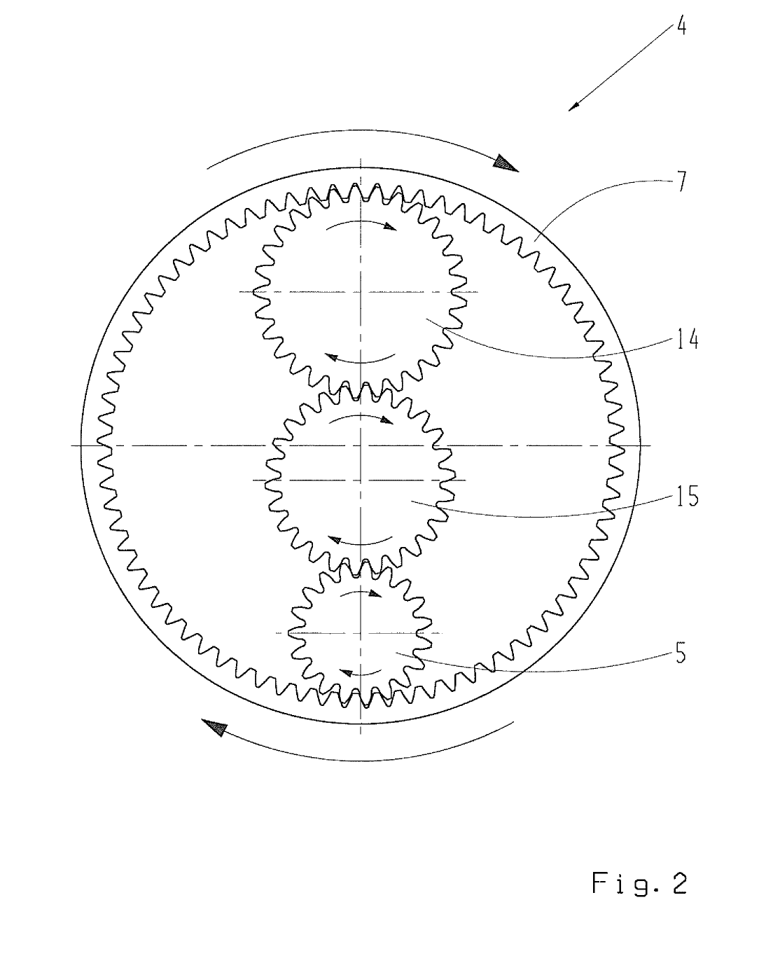

In addition to the first spur gear 5, the gearbox arrangement 4 has a further spur gear or second spur gear 14, shown in more detail in FIG. 2, which likewise meshes with the ring gear 7 and has a different number of teeth than the first spur gear 5. In addition, the two spur gears 5 and 14 engage with a common intermediate gear 15. Both second spur gear 14 and intermediate gear 15 are rotatably mounted on a shaft 16 and 17, respectively, which is constructed in a stationary manner. The gearbox arrangement 4 which is constructed as a power-split ring gear portal and the gear unit device 8 which is formed with four planet gears 10 are helically toothed in the area of their toothed wheels.

A working pressure angle in the area of the gear meshes between the first spur gear 5 and the ring gear 7 and the second spur gear 14 and ring gear 7 is identical in size. In addition, the working pressure angles between the first spur gear 5 and intermediate gear 15 and between the intermediate gear 15 and second spur gear 14 correspond at least approximately or about to the working pressure angle between the first spur gear 5 and ring gear 7 and between the second spur gear 14 and ring gear 7.

To reduce operating noises, a sum of the backlash between the first spur gear 5 and ring gear 7 and the sum of the backlashes between the first spur gear 5 and the intermediate gear 15, between the intermediate gear 15 and the second spur gear 14 and between the second spur gear 14 and the ring gear 7 are at least approximately or about equal to zero. The operating noises are reduced owing to the resulting identical rotation angle of the ring gear via the gear meshes between the first spur gear 5 and the intermediate gear 15, the intermediate gear 15 and the second spur gear 14, the second spur gear 14 and ring gear 7, and between the first spur gear 5 and ring gear 7 because a radial deflection of the first spur gear 5 occurs only to a slight extent in the event of a load change. This step does not depend on whether the teeth of the gearbox arrangement 4 and gear unit device 8 are formed as spur teeth or helical teeth.

In the present case, the ring gear 7 is formed with an even number of teeth, preferably equal to −74, to achieve a phase synchronicity of at least approximately or about 100%. In addition, the overlap contact ratio in the area of the teeth of the gearbox arrangement 4 is greater than two so that operating noises can be reduced to a minimum.

A transverse contact ratio and flank roughness in the area of the gearbox arrangement 4 are as small as possible in order to reduce gear loss factors, while the normal pressure angle is as large as possible. In this connection, a transverse contact ratio is less than or equal to one depending on the case of application and the roughness depth is less than or equal to 2 μm, while the normal pressure angle is greater than or equal to 25°.

Aside from improved efficiency, increasing the normal pressure angle also makes possible an appreciable improvement of the tooth base load carrying capacity and flank load carrying capacity in the area of the spur gears 4 and 14 and of the intermediate gear 15 and ring gear 7.

Under some circumstances depending upon the case of application, the steps described above for improving efficiency in the area of the gearbox arrangement 4 have a disadvantageous effect on the noise behavior of the gearbox arrangement 4, but this can be substantially compensated again by increasing the helix angle in the area of the teeth of the gearbox arrangement 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A gearbox arrangement (4) comprising:
an internally toothed ring gear (7);
an intermediate gear (15);
a first and second spur gear (5, 14) each meshing with the ring gear (7) with a predefined working pressure angle and engaging with the intermediate gear (15), at least one of the spur gears (5) being connected to a shaft (6) so as to be fixed with respect to rotation relative thereto; and the working pressure angles between the first and second spur gears (5, 14) and the ring gear (7) being at least about identical in size.

13. The gearbox arrangement according to claim 12, wherein each of the first and second spur gears (5, 14) engages with the intermediate gear (15) with a predefined working pressure angle; and wherein the working pressure angle between each of the spur gears (5, 14) and the intermediate gear (15) correspond respectively at least about to the working pressure angles between the spur gears (5, 14) and the ring gear (7).

14. The gearbox arrangement according to claim 12, wherein the first and second spur gears (5, 14) have different numbers of teeth.

15. The gearbox arrangement according to claim 12, comprising backlash between the first spur gear (5) and the ring gear (7) and backlashes between the first spur gear (5) and the intermediate gear (15), and the intermediate gear (15) and the second spur gear (14) and between the second spur gear (14) and the ring gear (7); and wherein the sum of the backlash between the first spur gear (5) and the ring gear (7) and the sum of the backlashes between the first spur gear (5) and the intermediate gear (15), between the intermediate gear (15) and the second spur gear (14), and between the second spur gear (14) and the ring gear (7) is at least about equal to zero.

16. The gearbox arrangement according to claim 12, further comprising a gear unit device (8) including a second ring gear (11); and wherein the second ring gear (11) is constructed with a number of teeth corresponding to an even natural number.

17. The gearbox arrangement according to claim 12, wherein the spur gears (5, 14) and the ring gear (7) and the spur gears (5, 14) and the intermediate gear (15) define a transverse contact ratio therebetween; and wherein the transverse contact ratio between the spur gears (5, 14) and the ring gear (7) and between the spur gears (5, 14) and the intermediate gear (15) is less than or equal to one.

18. The gearbox arrangement according to claim 12, wherein the spur gears (5, 14) and the ring gear (7), and the spur gears (5, 14) and the intermediate gear (15) define a normal pressure angle therebetween; and wherein the normal pressure angle between the spur gears (5, 14) and the ring gear (7) and between the spur gears (5, 14) and the intermediate gear (15) is greater than or equal to 25 degrees in each instance.

19. The gearbox arrangement according to claim 12, wherein there is a roughness depth defined in the area of the teeth of the spur gears (5, 14), of the ring gear (7) and of the intermediate gear (15) and wherein the roughness depth in the area of the teeth of the spur gears (5, 14), of the ring gear (7) and of the intermediate gear (15) is less than or equal to 2 μm in each instance.

20. The gearbox arrangement according to claim 12, wherein there is an overlap ratio defined between the spur gears (5, 14) and the ring gear (7), and between the spur gears (5, 14) and the intermediate gear (15); and wherein the overlap contact ratio between the spur gears (5, 14) and the ring gear (7) and between the spur gears (5, 14) and the intermediate gear (15) is greater than two in each instance.

21. The gearbox arrangement according to claim 12, wherein one of the spur gears (5) can be coupled with an output shaft of an electric machine (3) of an electro-portal axle (1) of a vehicle.

22. The gearbox arrangement according to claim 12, additionally comprising an electro-portal axle comprising a planetary gear arrangement having a sun gear (9), and wherein the ring gear (7) can be brought into an operative connection with the sun gear (9) of the planetary gear arrangement (8) of the electro-portal axle (1).

23. The gearbox arrangement according to claim 13, wherein the first and second spur gears (5, 14) have different numbers of teeth.

24. The gearbox arrangement according to claim 13, wherein there is a backlash between the first spur gear (5) and the ring gear (7) and a backlash between the first spur gear (5) and the intermediate gear (15), and the intermediate gear (15) and the second spur gear (14), and between the second spur gear (14) and the ring gear; and wherein the sum of the backlash between the first spur gear (5) and the ring gear (7) and the sum of the backlashes between the first spur gear (5) and the intermediate gear (15), between the intermediate gear (15) and the second spur gear (14), and between the second spur gear (14) and the ring gear (7) is at least about equal to zero.

25. The gearbox arrangement according to claim 14, wherein there is a backlash between the first spur gear (5) and the ring gear (7) and a backlash between the first spur gear (5) and the intermediate gear (15), and the intermediate gear (15) and second spur gear (14), and between the second spur gear (14) and the ring gear; and wherein the sum of the backlash between the first spur gear (5) and the ring gear (7) and the sum of the backlashes between the first spur gear (5) and the intermediate gear (15), between the intermediate gear (15) and the second spur gear (14) and between the second spur gear (14), and the ring gear (7) is at least about equal to zero.

26. The gearbox arrangement according to claim 13, wherein the ring gear (11) is constructed with a number of teeth corresponding to an even natural number.

27. The gearbox arrangement according to claim 13, wherein the spur gears (5, 14) and the ring gear (7) and the spur gears (5, 14) and the intermediate gear (15) define a transverse contact ratio therebetween; and wherein the transverse contact ratio between the spur gears (5, 14) and the ring gear (7) and between the spur gears (5, 14) and the intermediate gear (15) is less than or equal to one.

28. The gearbox arrangement according to claim 13, wherein the spur gears (5, 14) and the ring gear (7), and the spur gears (5, 14) and the intermediate gear (15) define a normal pressure angle therebetween; and wherein the normal pressure angle between the spur gears (5, 14) and the ring gear (7) and between the spur gears (5, 14) and the intermediate gear (15) is greater than or equal to 25 degrees in each instance.

29. The gearbox arrangement according to claim 13, wherein there is a roughness depth defined in the area of the teeth of the spur gears (5, 14), of the ring gear (7) and of the intermediate gear (15) and wherein the roughness depth in the area of the teeth of the spur gears (5, 14), of the ring gear (7) and of the intermediate gear (15) is less than or equal to 2 μm in each instance.

30. The gearbox arrangement according to claim 13, wherein there is an overlap ratio defined between the spur gears (5, 14) and the ring gear (7), and between the spur gears (5, 14) and the intermediate gear (15); and wherein the overlap contact ratio between the spur gears (5, 14) and the ring gear (7) and between the spur gears (5, 14) and the intermediate gear (15) is greater than two in each instance.

31. The gearbox arrangement according to claim 13, wherein one of the spur gears (5) can be coupled with an output shaft of an electric machine (3) of an electro-portal axle (1) of a vehicle.
